(19) United States
(12) Patent Application Publication
(10) Pub. No.: US 2024/0196152 A1
(43) Pub. Date: Jun. 13, 2024

(54) SPATIAL AUDIO PROCESSING METHOD AND APPARATUS THEREFOR

(71) Applicant: GAUDIO LAB, INC., Seoul (KR)

(72) Inventors: Hyunjoo CHUNG, Seoul (KR); Seungbum KIM, Seoul (KR); Jeonghun SEO, Seoul (KR); Jaegyu NOH, Seoul (KR); Changsub KIM, Seoul (KR); Hwanhee KIM, Seoul (KR); Hyunoh OH, Gyeonggi-do (KR)

(21) Appl. No.: 18/136,788

(22) Filed: Apr. 19, 2023

(30) Foreign Application Priority Data
Dec. 13, 2022 (KR) 10-2022-0174174

(51) Int. Cl. H04S 7/00; G06F 3/0346; G06T 7/70; G06V 40/16

(52) U.S. Cl. CPC H04S 7/303; G06F 3/0346; G06T 7/70; G06V 40/172; G06T 2207/10016; G06T 2207/30201; H04S 2400/11

(57) ABSTRACT

A spatial audio processing method may include an operation of obtaining first movement information of a video reproduction device, an operation of obtaining second movement information of an audio reproduction device, an operation of obtaining an audio signal, and an operation of performing, based on whether the first movement information satisfies a predetermined condition, spatial audio processing on the audio signal, wherein, in case that the first movement information satisfies the predetermined condition, the spatial audio processing may be performed based on the second movement information, and in case that the first movement information does not satisfy the predetermined condition, the spatial audio processing may be performed based on the first movement information and the second movement information.

### CROSS-REFERENCE TO RELATED APPLICATION(S)

This application is based on and claims priority under 35 U.S.C. 119 to Korean Patent Application No. 10-2022-0174174, filed on Dec. 13, 2022, in the Korean Intellectual Property Office, the disclosure of which is herein incorporated by reference in its entirety.

### TECHNICAL FIELD

The present disclosure relates to a spatial audio processing method and an apparatus therefor. The present disclosure relates to a method and apparatus for embodying immersive binaural rendering by using a mobile device such as a smartphone and the like and a reproduction device such as headphones, earphones, and the like.

### BACKGROUND ART

To immersively reproduce a sound scene of content in a three-dimensional space when a user device (e.g., a mobile device, earphones, headphones, and the like) reproduces the content, spatial audio processing using binaural rendering technology is essential. In this instance, when a user consumes the content, the image of the content may be reproduced via a display of a mobile device and the sound of the content may be reproduced via earphones or headphones of the user. In this instance, to immersively reproduce the content, spatial audio technology that positions a sound source of the content may be used. By using the spatial audio technology, the user device may reproduce a content so that sound is heard from a location of an object in an image of the content or may reproduce a sound scene of a three-dimensional space expressed in an image so as to provide an immersive sound to the user. Via the spatial audio technology, the user may feel as if sound of the content were reproduced from a location in an image reproduced via the display screen of the user device, as opposed to from earphones, headphones, or the like. In this instance, in case that movement information of the head of the user is not taken into consideration, synchronization (display-alignment) between an image and sound may not be maintained. Accordingly, there is a desire for a spatial audio processing method for maintaining synchronization between an image and sound.

### DISCLOSURE OF INVENTION

### Technical Problem

The present disclosure is to provide a spatial audio processing method for maintaining synchronization between an image and sound, and an apparatus therefor.

### Solution to Problem

The present disclosure provides a spatial audio processing method and an apparatus therefor.

In the present specification, a spatial audio processing method includes an operation of obtaining first movement information of a video reproduction device, an operation of obtaining second movement information of an audio reproduction device, an operation of obtaining an audio signal, and an operation of performing spatial audio processing on the audio signal based on whether the first movement information satisfies a predetermined condition, wherein, in case that the first movement information satisfies the predetermined condition, the spatial audio processing is performed based on the second movement information, and in case that the first movement information does not satisfy the predetermined condition, the spatial audio processing is performed based on the first movement information and the second movement information.

The spatial audio processing method further includes an operation of obtaining information associated with whether the display of the video reproduction device that displays a video is activated, and the predetermined condition is a case in which the display is deactivated.

In the present specification, a spatial audio processing apparatus for performing spatial audio processing includes a processor, and the processor is configured to obtain first movement information of a video reproduction device, to obtain second movement information of an audio reproduction device, to obtain an audio signal, and to perform spatial audio processing on the audio signal based on whether the first movement information satisfies a predetermined condition, wherein spatial audio processing is performed based on the second information in case that the first movement information satisfies the predetermined condition, the spatial audio processing is performed based on the first movement information and the second movement information in case that the first movement information does not satisfy the predetermined condition, and the spatial audio processing apparatus is the video reproduction device or the audio reproduction device.

The processor obtains information associated with whether the display of the video reproduction device that displays a video is activated, and the predetermined condition is a case in which the display is deactivated.

In addition, in the present specification, the first movement information is obtained by an inertial measurement unit (IMU) of the video reproduction device, the second movement information is obtained by an IMU of the audio reproduction device, and each of the IMU of the video reproduction device and the IMU of the audio reproduction device includes at least one of an acceleration sensor, an angular velocity sensor (gyroscope), and a geomagnetic sensor (magnetometer).

The predetermined condition is a case in which a quaternion value of the video reproduction device is greater than a predetermined value, and the quaternion value is obtained based on a value obtained from at least one of the acceleration sensor, the angular velocity sensor, and the geomagnetic sensor of the video reproduction device.

The predetermined condition satisfies at least one of a case in which an acceleration obtained via the acceleration sensor of the video reproduction device is greater than a first value, a case in which a variation in an angular velocity obtained via the angular velocity sensor of the video reproduction device is greater than a second value, and a case in which a variation in a magnetic field direction obtained via the geomagnetic sensor is greater than a third value.

The predetermined condition is a case in which the video reproduction device is determined as moving in a predetermined pattern repeatedly based on the first movement information.

The first value, the second value, and the third value are values configured by learning information associated with a movement of a user of the video reproduction device and the audio reproduction device, and the learning is performed via machine learning.

The predetermined condition is a case in which the video reproduction device is located beyond a range of an angle of field of the user of the video reproduction device and the audio reproduction device, and the range of the angle of field of the user is determined based on the audio reproduction device.

The predetermined pattern corresponds to the first movement information repeated during a predetermined period of time.

The video reproduction device includes at least one of a sensor that recognizes a face of a user of the video reproduction device and the audio reproduction device, a sensor that recognizes a direction of a line of sight of the user, and a sensor that recognizes a direction of the face of the user, and the predetermined condition satisfies at least one of a case in which the face of the user is not recognized, a case in which the direction of the face of the user is not toward a display of the video reproduction device that displays a video, and a case in which the direction of the line of sight of the user is not toward the display.

The present disclosure provides a spatial audio processing method and an apparatus therefor, so as to maintain synchronization between an image and sound.

### Advantageous Effects of Invention

The above and other aspects, features, and advantages of the present disclosure will be more apparent from the following detailed description taken in conjunction with the accompanying drawings, in which:

### BRIEF DESCRIPTION OF DRAWINGS

FIG. 1 is a diagram illustrating a spatial audio processing method according to an embodiment of the present disclosure;

FIG. 2 is a diagram illustrating a method of performing spatial audio processing based on a movement of a user device according to an embodiment of the present disclosure;

FIG. 3 is a block diagram illustrating the configuration of an apparatus for performing a spatial audio processing method according to an embodiment of the present disclosure; and

FIG. 4 is a diagram illustrating a spatial audio processing method according to an embodiment of the present disclosure.

### BEST MODE FOR CARRYING OUT THE INVENTION

Terms that are generally and widely used at the present are selected in consideration of functions in the present disclosure, and are used in the present specification. However, the terms may be changed depending on the intention of those skilled in the corresponding art field, practices, new technology, or the like. In addition, there may be a term arbitrarily selected by an applicant in some cases. In this instance, the term may be defined in the corresponding description of the disclosure. Therefore, it should be construed that the terms used in the present specification needs to be comprehended based on the substantial meaning of the terms and the overall descriptions of the present specification, not based on the names of the terms.

A user device such as a virtual reality (VR) device, an augmented reality (AR) device, and the like may be provided in a form worn on the head of a user. The device provided in a form worn on the head may be described as a head mounted display (HMD) device. Content including a video and sound may be reproduced (output) via such an HMD device. An HMD device may include a display device that outputs a video and a sound reproduction device. A spatial audio processing may be performed on content by using only spatial information (e.g., location information, direction information, and the like) of the HMD device. The HMD device is worn on the head of a user, and thus a direction (the field of vision) in which the user sees a display may match a movement of the head of the user, and the difference (e.g., an angle or the like) between an ear of the user and the direction (the field of vision) in which the user sees the display is always constant (maintained). That is, a reference direction of a video and sound that is used for spatial audio processing on content output via the HMD device may be always constant. Via the spatial audio processing by using spatial audio technology, the HMD device may reproduce content so that sound is heard from the location of an object in a video of the content or may reproduce a sound scene of a three-dimensional space expressed in an image so as to provide an immersive sound to the user. In case that spatial audio processing is performed via the spatial audio technology, a user may feel as if the sound of the content were reproduced from the location of an object in a video reproduced via a display screen of the user device, as opposed to from earphones, headphones, or the like.

However, in case that the user device is not an HMD device, a reference direction of a video and sound that is used for spatial audio processing may be changed depending on a user action (e.g., a posture, a movement, and the like). The user device different from an HMD device may be a video reproduction device including a display and is capable of reproducing a video, such as a smartphone, a tablet PC, or the like, or a sound reproduction device that is capable of reproducing sound such as earphones, headphones, or the like. Content including a video and sound may be reproduced (output) via the user device different from an HMD. A user may consume a video by holding a video reproduction device in a hand. Therefore, a direction (the field of vision) in which the user sees the video reproduction device may be changed according to a movement of a hand and/or an arm of the user. That is, the reference direction for the video reproduction device that the user gazes at may be changed depending on a movement of a hand and/or an arm of the user. In the same manner, the user may wear a sound reproduction device, and thus a reference direction for the sound device from which the user listens to sound may be changed according to a rotation direction of the head of the user. That is, at least one of the reference direction for the video reproduction device and the reference direction for the sound device may be changed according to a user action. Therefore, a reference direction for performing spatial audio processing on content (the reference direction for the reproduction device and the reference direction for the sound device) may not be constant.

Hereinafter, a method of performing spatial audio processing on content reproduced in a user device different from an HMD device is described.

In order to perform spatial audio processing on content reproduced in the user device different from an HMD device, spatial information (e.g., location information, direction information) of the video reproduction device and the sound reproduction device may need to be tracked, respectively. Spatial audio processing on content may be performed using spatial information of the video reproduction device and the sound reproduction device obtained via tracking. For example, in case that a main character in a video speaks his/her lines while a user consumes a movie content, spatial audio processing may be performed so that sound is reproduced from the location of the main character in a screen of the video reproduction device. In this instance, a device (a source device) that stores an audio signal on which spatial audio processing is to be performed may be a video reproduction device capable of reproducing a video. For example, the source device may be a smartphone or a tablet PC. The source device may store an internal storage space of an audio signal source device for storage. Alternatively, in case that content is reproduced via a streaming service, the source device may receive an audio signal via a streaming server. The source device may directly render an audio signal (perform spatial audio processing), and may transmit the rendered audio signal (the spatial audio processed-audio signal) to the audio reproduction device. Alternatively, the source device may transmit an audio signal to the audio reproduction device, and the audio reproduction device may render the audio signal and may reproduce the rendered audio signal. Rendering described in the present specification may be a process of performing spatial audio processing, a signal to be rendered may be an audio signal on which spatial audio processing is to be performed, and a rendered audio (signal) may be a spatial audio processed-audio (signal).

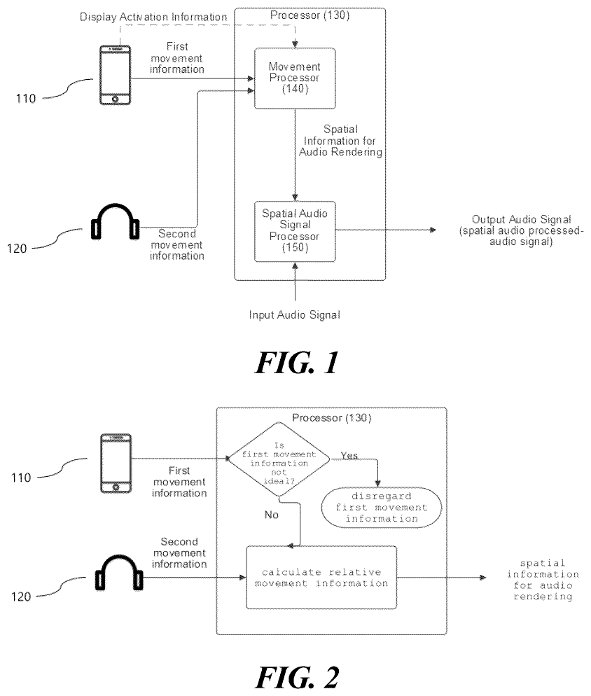

FIG. 1 is a diagram illustrating a spatial audio processing method according to an embodiment of the present disclosure.

Referring to FIG. 1, a processor 130 may obtain (may receive input of) first movement information that is movement information of a video reproduction device (a first device 110) and second movement information that is movement information of an audio reproduction device (a second device 120). In addition, the processor 130 may obtain (receive) an input audio signal. The processor 130 may perform spatial audio processing based on first device movement information, second device movement information, and an input audio signal, and may obtain (output) the spatial audio processed-audio signal. In this instance, the first and the second device movement information may be spatial information of the above-described video reproduction device and sound reproduction device (i.e., location information and direction information of the video reproduction device and the sound reproduction device), and the input audio signal may be an audio signal that has been described above. Specifically, the processor 130 may be configured with a movement processor 140 and a spatial audio signal processor 150. The movement processor 140 may obtain first device movement information and second device movement information. The spatial audio signal processor 150 may obtain an input audio signal. Based on the first device movement information and the second device movement information, the movement processor 140 may produce (obtain) spatial information for audio rendering. The movement processor 140 may transmit spatial information for audio rendering to the spatial audio signal processor 150. Based on the spatial information for audio rendering and an input audio signal, the spatial audio signal processor 150 may perform spatial audio processing and may obtain a spatial audio-processed audio signal. In this instance, the processor 130 may be a processor included in an apparatus that performs spatial audio processing. Therefore, in case that the video reproduction device 110 performs spatial audio processing, the processor 130 may be a processor included in the video reproduction device 110. In case that the audio reproduction device 120 performs spatial audio processing, the processor 130 may be a processor included in the audio reproduction device 120. A spatial audio processed-audio signal may be output via the audio reproduction device 120.

The first movement information may be obtained by an inertial measurement unit (IMU) included in the video reproduction device 110, and the second movement information may be obtained by an IMU included in the audio reproduction device 120. The IMU may be a device including an acceleration sensor, an angular velocity sensor (gyroscope), and a geomagnetic sensor (magnetometer). For example, direction information which is obtained by the IMU in association with each of the video reproduction device 110 and the audio reproduction device 120 may be expressed as yaw (y), pitch (p), and roll (r) which indicate a rotation angle about z, y, and x axes in a three-dimensional space. The direction information of the video reproduction device 110 may be expressed as a rotation angle of (y_m, p_m, r_m). In the same manner, the direction information of the audio reproduction device 120 may be expressed as a rotation angle of (y_t, p_t, r_t). In this instance, the direction information (y, p, r) needed for spatial audio processing may be expressed as given in Equation 1 below.

(y,p,r)=(y_t−y_m,p_t−p_m,r_t−r_m) [Equation 1]

The direction information of Equation 1 may be a result obtained by tracking a video positioned in a virtual space according to the location of a display of the video reproduction device 110 and, simultaneously, taking into consideration the movement (direction) of the head of a user who wears the audio reproduction device 120. The processor 130 may perform spatial audio processing using a (y, p, r) value obtained via Equation 1. For example, in case that the location of the display of the video reproduction device 110 moves to the right, the location of an audio signal may also be rotated to the right and may be positioned. In case that the user moves the video reproduction device 110 to the left, and simultaneously, the direction of the head (the line of sight) also equally moves to the left, there is no difference in directions between the video reproduction device 110 and the audio reproduction device 120, and thus an audio signal in a virtual space may also constant when being processed.

In addition, the processor 130 may perform spatial audio processing based on only the horizontal direction of the movement information of the video reproduction device 110, as opposed to using a three-dimensional space. That is, the processor 130 may perform spatial audio processing based on only horizontal rotation of the video reproduction device 110. In this instance, the direction information (y, p, r) needed for spatial audio processing may be expressed as given in Equation 2 below.

(y,p,r)=(y_t−y_m,p_t,r_t) [Equation 2]

Equation 2 may be expressed as a quaternion value, as opposed to being expressed as a rotation angle about three axes. In this instance, the quaternion value may be obtained based on any one or more of the values obtained from an acceleration sensor, an angular velocity sensor, and a geomagnetic sensor. Specifically, the quaternion value may be obtained based on all of the values obtained from the acceleration sensor, the angular velocity sensor, and the geomagnetic sensor. Alternatively, the quaternion value may be obtained based on values obtained from the acceleration sensor and the angular velocity sensor.

The acceleration sensor may be a sensor that obtains a value by measuring acceleration when the video reproduction device 110 and/or the audio reproduction device 120 moves. The angular velocity sensor may be a sensor that obtains a value by measuring an angular velocity when the video reproduction device 110 and/or the audio reproduction device 120 rotates. The geomagnetic sensor may be a sensor that obtains a value by measuring a direction of a magnetic field around the video reproduction device 110 and/or audio reproduction device 120 when the video reproduction device 110 and/or the audio reproduction device 120 moves.

In case that the movement of the video reproduction device 110 and the audio reproduction device 120 is ideal, the processor 130 may perform spatial audio processing based on the above-described method. However, in case that the above-described spatial audio processing method is performed when the movement of the video reproduction device 110 and the audio reproduction device 120 is not ideal, that is, in the situation in which a movement of a video reproduced in a display of the video reproduction device 110 does not need to be taken into consideration, this may make a user confused. The situation that does not need to take into consideration a movement of a video may include, for example, the case in which the video reproduction device 110 rapidly moves, the case in which the video reproduction device 110 moves in a repetitive pattern, the case in which the display of the video reproduction device 110 is turned off (i.e., the case in which a video screen is turned off), or the like. In other words, in case that the above-described spatial audio processing method is performed in the situation that does not need to take into consideration a movement of a video, a reference direction is changed, and thus a user may be confused. In case that the spatial audio processing is performed by using the movement information of both the video reproduction device 110 and the audio reproduction device 120, an audio content that a user consumes may rapidly vary and the quality of the audio content may deteriorate, which is a drawback. For example, in case that a user drops the video reproduction device 110 (a source device), which has been carried by the user and stores an audio signal, a rendered audio signal may be rendered as if the rendered signal would relatively rapidly rise in a virtual space. Therefore, the user may feel awkward when appreciating the rendered signal. As another example, in case that the user consumes a rendered audio signal while walking with holding the video reproduction device 110 in a hand, the location of the video reproduction device 110 may be continuously and repeatedly changed. That is, while the user is walking, the user may swing his or her arms back and forth, and thus the relative location of the video reproduction device 110 may be changed back and forth. Therefore, a rendered audio signal may also be relatively and continuously changed. In this instance, an audio signal may be rendered only based on movement information of the audio reproduction device 120, not based on the movement information of the video reproduction device 110, and a user may consume a rendered audio content having stable quality. As another example, in case that a user consumes an audio content excluding a video, an audio signal may be rendered only based on the movement information of the audio reproduction device 120, not based on the movement information of the video reproduction device 110. As an example of the case in which a user consumes only an audio content excluding a video may include the case in which the user does not watch a display of the video reproduction device 110, the case in which the display of the video reproduction device 110 is deactivated (turned off), the case in which the video reproduction device 110 is located beyond the range of an angle of field of the user.

Although any one of a movement of the video reproduction device 110 and a movement of the audio reproduction device 120 is not ideal, if the not ideal situation temporarily occurs, the processor 130 may render an audio signal based on the above-described method (i.e., by taking into consideration movement information of both the video reproduction device 110 and the audio reproduction device 120). That is, in the case of the situation in which the user continuously watches a video, although an unideal case temporarily occurs, the processor 130 may render an audio signal based on the above-described method (i.e., by taking into consideration movement information of both the video reproduction device 110 and the audio reproduction device 120). For example, the case in which the line of sight of a user does not face the video reproduction device 110 due to a predetermined reason (e.g., the user talks to someone, the user temporarily looks back when someone calls, or the like) while the user watches a video, corresponds to the situation in which the user continuously watches a video, and thus it is more efficient and natural that the processor 130 renders an audio signal based on the above-described method (i.e., by taking into consideration movement information of both the video reproduction device 110 and the audio reproduction device 120).

Hereinafter, provided is a description of a method of performing spatial audio processing in case that any one of a movement of the video reproduction device 110 and a movement of the audio reproduction device 120 is not ideal.

1) Case in which Movement Information of the Video Reproduction Device 110 is Higher than a Reference Value

In case that the video reproduction device 110 is moved rapidly by a user, the processor 130 may not need to take into consideration the movement information of the video reproduction device 110 when rendering an audio signal. For example, in the case in which a user moves the video reproduction device 110 to another place (e.g., in the case in which a user moves the video reproduction device 110 so as to place the same on a table, in the case in which the user puts the video reproduction device 110 in a pocket, and the like), in the case in which the video reproduction device 110 falls off, or the like, the video reproduction device 110 may be moved rapidly. In case that the video reproduction device 110 is rapidly moved, the processor 130 may compare a value obtained via the IMU of the video reproduction device 110 with a reference value. Depending on a comparison result, the movement information of the video reproduction device 110 may or may not be used for rendering of an audio signal. Specifically, in case that at least one of the values obtained via an acceleration sensor, a gyro sensor, and a geomagnetic sensor of the IMU exceeds the reference value, in case that a quaternion value exceeds a reference value, and in case that a variation in a movement of the video reproduction device 110, which is determined based on a value obtained via the acceleration sensor, the gyro sensor, and the geomagnetic sensor of the IMU, exceeds a reference value, the processor 130 may render an audio signal not based on the movement information of the video reproduction device 110. For example, the case in which the video reproduction device 110 moves at M_1 degrees or more during a period of time corresponding to N_1 may be the case in which a variation in the movement of the video reproduction device 110 exceeds a reference value. For example, in case that the video reproduction device 110 is determined as moving at 5 degrees or more during 0.5 seconds, the processor 130 may render an audio signal not based on the movement information of the video reproduction device 110. Table 1 is an example of a movement of the video reproduction device 110, and may show a velocity when the movement reproduction device 110 moves over a relative time (a variation in an angular velocity per unit time).

Referring to Table 1, in case that a variation in an angular velocity per unit time during a relative time interval corresponding to a predetermined value of 2 exceeds 5, the processor 130 may not use the movement information of the video reproduction device 110 when rendering an audio signal. In this instance, during relative time intervals 40 to 42, the processor 130 may render an audio signal not based on the movement information of the video reproduction device 110. As another example, in case that the velocity of the video reproduction device 110 is changed from M_2 to M_3 during a period of time from N_2 to N_3, the processor 130 may obtain an acceleration of the video reproduction device 110 (e.g., a variation in time (N_2-N_3) and a variation in velocity (M_2-M_3)). In this instance, in case that the obtained acceleration exceeds a reference value, the processor 130 may render an audio signal not based on the movement information of the video reproduction device 110. As another example, in case that a value (e.g., a variation in a magnetic field direction) measured by a geomagnetic sensor exceeds a reference value, the processor 130 may render an audio signal not based on the movement information of the video reproduction device 110. For example, in case that the magnetic field direction measured by the geomagnetic sensor exceeds the reference value, the processor 130 may render an audio signal not based on the movement information of the video reproduction device 110. That is, the processor 130 may determine a degree of inclination of the video reproduction device 110 based on the direction of gravity (e.g., a degree that the direction of the video reproduction device 110 changes), and may render an audio signal. As another example, in case that a quaternion value exceeds a reference value, the processor 130 may render an audio signal not based on the movement information of the video reproduction device 110.

In the above-described example, reference values respectively compared with values measured by an acceleration sensor, a gyro sensor, and a geomagnetic sensor, and a quaternion value may be the same as, or different from each other. In addition, in case that at least any one of the values measured by the acceleration sensor, the gyro sensor, and the geomagnetic sensor, and the quaternion values exceeds a reference value, the processor 130 may render an audio signal not based on the movement information of the video reproduction device 110.

2) Case in which the Video Reproduction Device 110 Moves in a Repetitive Pattern

In case that the video reproduction device 110 moves in a repetitive pattern, the processor 130 may render an audio signal not based on movement information of the video reproduction device 110. In case that the movement pattern of the video reproduction device 110 is the same as or similar to a predetermined pattern, the processor 130 may render an audio signal not based on movement information of the video reproduction device 110. For example, in case that a user moves, holding the video reproduction device 110 in a hand or in case that the user moves, carrying the video reproduction device 110 in a bag, a pocket, or the like, the video reproduction device 110 may move in a repetitive pattern. This may be the case in which the user consumes an audio content without watching the video reproduction device 110. Therefore, the processor 130 may render an audio signal not based on the movement information of the video reproduction device 110. Table 2 is an example of a repetitive movement pattern of the video reproduction device 110, and shows a variation in angle (yaw) during a relative time.

### 3) Case of Personalizing and Utilizing User Information Via Machine Learning

The above-described cases 1) and 2) may be cases in which a user does not watch or is incapable of watching a video via the video reproduction device 110. As described above, in case that the processor 130 performs rendering based on the case in which a variation of the video reproduction device 110 is greater than a reference value, the case in which a repetitive pattern is similar to or same as a predetermined pattern, and the like, there may be a problem in that a feature for each user may not be applied. That is, features of users are different from each other, and thus a method applied to all users in common such as the above-described case 1) and 2) may not apply a feature for each user. Therefore, the processor 130 may use a result obtained via learning (e.g., machine learning or the like) based on each user data (e.g., a value obtained by each sensor of an IMU) when rendering an audio signal. For example, in case that a user moves, holding the video reproduction device 110 in a hand, the angle of a moving arm or the like may be different for each user. Therefore, a result obtained via learning in consideration the angle of an arm corresponding to each user and the like may be used for rendering an audio signal. In this instance, learning may be performed by the video reproduction device 110. That is, a result obtained via learning may be configured as a new reference value or may be a predetermined pattern.

4) Case in which the Video Reproduction Device 110 is Located Beyond the Angle of Field of a User

The angle of field of a human generally has a range of approximately 200 to 220 degrees in the horizontal direction and a range of approximately 130 to 135 degrees in the vertical direction. The angle of field may be defined based on the direction of the head of a person. In this instance, the direction of a fixation point, that is, the direction of the center of the angle of field may be the same as a reference direction of the audio reproduction device 120 such as headphones/earphones worn on the head or both ears of a user. Therefore, the case in which the video reproduction device 110 is located beyond the angle of field that is based on the reference direction of the audio reproduction device 120 may be the case in which the user is incapable of watching a video via the video reproduction device 110. That is, in case that the video reproduction device 110 is located beyond the range of the angle of field of a user, the processor 130 may render an audio signal not based on movement information of the video reproduction device 110. In addition, 180 degrees in the horizontal direction and 120 degrees in the vertical direction may be configured as a new reference value, and the processor 130 may render an audio signal not based on the movement information of the video reproduction device 110 in case that the video reproduction device 110 is located beyond the range of the new reference value of the user.

5) Case in which a Display of the Video Reproduction Device 110 is Deactivated (Turned Off)

Generally, a user consumes a video and an audio content at the same time when content is reproduced. However, sometimes, a user may consume only an audio content without watching a video. That is, the user may consume only an audio content in the state in which the display of the video reproduction device 110 is deactivated (turned off). This is the case in which a user consumes only an audio content intentionally without appreciating a video of the video reproduction device 110. The processor 130 may render an audio signal based on only the movement information of the audio reproduction device 120 without taking into consideration the movement information of the video reproduction device 110. Whether the display of the video reproduction device 110 is activated (turned on or off) may be determined based on separate information (e.g., a flag, Display Activation Information of FIG. 1). The processor 130 may receive information associated with whether the display is activated (turned on or off) and may determine whether the display is activated (turned on or off). In case that the display is deactivated (turned off), the processor 130 may render an audio signal not based on the movement information of the video reproduction device 110.

6) Case in which the Direction of the Head of a User or the Line of Sight does not Face the Display

To consume a video and an audio content at the same time when content is reproduced, a user may need to gaze at the display of the video reproduction device 110 that reproduces a video. That is, the direction of the head of the user or the line of sight may need to face in the direction of the display. The video reproduction device 110 such as a smartphone may include a sensor such as a camera or infrared camera, a flood illuminator, a dot projector, an iris sensor, and the like for recognizing the face of a user, the direction of the face, and the direction of the line of sight. Using the sensors, the video reproduction device 110 may recognize the face of a user, and may trace the direction of the face or the direction of the line of sight. In case that, through the same, the user is determined as not watching a video that is being reproduced, the processor 130 may render an audio signal not based on the movement information of the video reproduction device 110. That is, in case that the face of the user is not recognized, or the direction of the face of the user or the direction of the line of sight does not face the video reproduction device 110, the processor 130 may render an audio signal not based on the movement information of the video reproduction device 110. In addition, although the user gazes at the video reproduction device 110, in case that the video reproduction device 110 rotates and the display is not located in the direction of the line of sight, the processor 130 may render an audio signal not based on the movement information of the video reproduction device 110.

As described in the above-described cases 1) to 6), in case that an audio signal is rendered based on only the movement information of the audio reproduction device 120, not based on the movement information of the video reproduction device 110, the reference direction for spatial audio processing may be determined based on the audio reproduction device 120 or the location of the head of the user.

While an audio content is reproduced, both rendering performed using the movement information of the video reproduction device 110 and the audio reproduction device 120 and rendering performed without using the movement information of the video reproduction device 110 may be used. In this instance, in order to provide an appropriate audio content to the user, there is needed a definition for a modification section in which an audio content rendered using the movement information of both the video reproduction device 110 and the audio reproduction device 120 is converted into an audio content rendered without using the movement information of the video reproduction device 110 and the converted audio content is reproduced. In case that rendering is performed not based on the movement information of the video reproduction device 110, a display (screen) in which the location for display-alignment needs to be defined is not present, and thus a reference direction for rendering needs to be configured and a method of configuring a reference direction is described below.

A first method of configuring a reference direction may be a method of matching the direction information of a point of view at which rendering based on the above-described cases 1) to 6) begins and the direction information of the audio reproduction device 120. For example, in case that the video reproduction device 110 is located beyond the angle of field of a user, the processor 130 may configure a reference direction based on the location of the video reproduction device 110 and may perform rendering only based on the movement information of the audio reproduction device 120. Subsequently, in case that the video reproduction device 110 moves again within the range of the angle of field of the user, the processor 130 may perform rendering based on the movement information of each of the video reproduction device 110 and the audio reproduction device 120. By configuring a reference direction based on the described method, the user may not feel a change in an audio content that is being reproduced and may naturally continue appreciation.

A second method may be a method of changing a reference direction from direction information (y_0, p_0, r_0) of a point of view at which rendering based on the above-described cases 1) to 6) begins to the direction of the head of the user (y_t, p_t, r_t). That is, the method may configure a reference point based on a head orientation of the user. The processor 130 may perform a process of matching the head orientation of the user and a reference direction of a scene (an audio scene) of a video corresponding to an audio signal (an audio signal) to be rendered. For example, the processor 130 may rotate (change) the reference direction by ((y_t-y_0)/N, (p_t-p_0)/N, (r_t-r_0)/N) for each second during N seconds agreed upon in advance, so as to configure a final reference direction. This may assume the case in which the direction of a head is constant while the reference direction is rotated (changed). For example, in case that the user falls the video reproduction device 110 off from a hand, it is the case in which display-alignment is not maintained, and thus the processor 130 may configure a reference direction based on the direction of the head of the user and may perform rendering based on the movement information of the audio reproduction device 120.

The processor 130 may render an audio signal in a fixed form agreed upon in advance without taking into consideration both movement information of the video reproduction device 110 and the movement information of the audio reproduction device 120.

FIG. 2 is a diagram illustrating a method of performing spatial audio processing based on a movement of a user device according to an embodiment of the disclosure.

FIG. 2 is a diagram illustrating a process of performing rendering based on the above-described cases 1) to 6). Specifically, FIG. 2 is a process of obtaining spatial information for audio rendering of FIG. 1.

Referring to FIG. 2, the processor 130 may obtain first movement information of the video reproduction device 110 and second movement information of the audio reproduction device 120. The processor 130 may determine whether the first movement information is not ideal. In this instance, an unideal case may be a situation corresponding to at least one of the above-described cases 1) to 6). In case that the first movement information is not ideal, the first movement information may not be used when relative movement information is calculated. Conversely, in case that the first movement information is ideal, the first movement information may be used for calculating relative movement information. That is, in case that the first movement information is not ideal, the processor 130 may calculate relative movement information by using only the second movement information. In case that the first movement information is ideal, the processor 130 may calculate relative movement information by using the first movement information and the second movement information. The processor 130 may output the calculated relative movement information, and the calculated relative movement information may be spatial information for audio rendering. Calculating relative movement information may be the same as configuring a reference direction that has been described above. The processor 130 of FIG. 2 may be the movement processor 140 of FIG. 1.

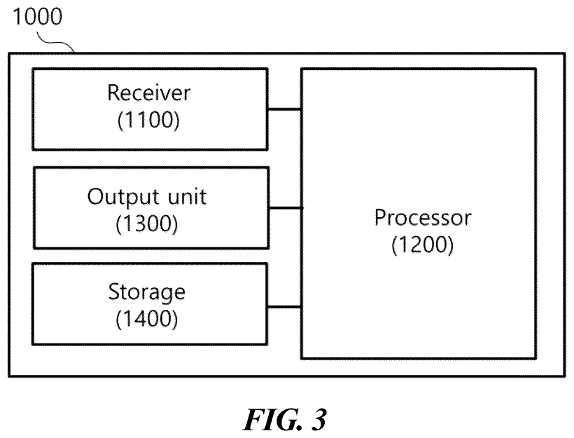

FIG. 3 is a block diagram illustrating the configuration of an apparatus for performing a spatial audio processing method according to an embodiment of the present disclosure.

According to an embodiment, a spatial audio processing apparatus 1000 may include a receiver 1100, a processor 1200, an output unit 1300, and a storage 1400. However, not all the component elements illustrated in FIG. 3 are essential component elements of the spatial audio processing apparatus. The spatial audio processing apparatus 1000 may additionally include a component element that is not illustrated in FIG. 3. Furthermore, at least part of the component elements of the spatial audio processing apparatus 1000 illustrated in FIG. 3 may be omitted. For example, the spatial audio processing apparatus 1000 according to an embodiment may not include the receiver 1100 and the output unit 1300. The spatial audio processing apparatus of FIG. 3 may be the video reproduction device 110 or the audio reproduction device 120 which is described in the present specification.

The receiver 1100 may receive an input content that is input to the spatial audio processing apparatus 1000. The receiver 1100 may receive content that is to be spatial audio processed by the processor 1200. An input content may include a video and an audio content. In addition, the audio content may be a single object signal or a mono signal. The audio content may be a multi-object or multi-channel signal. According to an embodiment, the receiver 1100 may include an input terminal that receives an input content transmitted in a wired manner. In addition, the receiver 1100 may include a wireless reception module that receives an input content transmitted in a wireless manner.

According to an embodiment, the spatial audio processing apparatus 1000 may include a separate decoder. In this instance, the receiver 1100 may receive an encoded bit stream of an input content. In addition, an encoded bitstream may be decoded into an input content via a decoder.

According to an embodiment, the receiver 1100 may be equipped with a transceiving part for performing data transmission or reception with external devices via a network. The receiver 1100 may include a wired transceiving terminal for receiving data transmitted in a wired manner. In addition, the receiver 1100 may include a wireless transceiving module for receiving data transmitted in a wireless manner. In this instance, the receiver 1100 may receive data transmitted in a wireless manner using a Bluetooth or Wi-Fi communication method. In addition, the receiver 1100 may receive data transmitted according to a mobile communication standard such as long-term evolution (LTE), an LTE-advanced, and the like, but the present disclosure is not limited thereto. The receiver 1100 may receive various types of data transmitted according to various wired/wireless communication standards.

The processor 1200 may control the overall operation of the spatial audio processing apparatus 1000. The processor 1200 may control each component element of the spatial audio processing apparatus 1000. The processor 1200 may perform operations and processing on various data and signals. The processor 1200 may be embodied as hardware in the form of a semi-conductive chip or an electric circuit, or may be embodied as software that controls hardware. The processor 1200 may be embodied in the form of a combination of hardware and software. For example, the processor 1200 may control operation of the receiver 1100, the output unit 1300, and the storage 1400 by implementing at least one program. In addition, the processor 1200 may implement at least one program, so as to perform operations (a method) disclosed in the present specification.

The output unit 1300 may output an output content. The output unit 1300 may output a spatial audio processed-audio content obtained by the processor 1200. In this instance, the spatial audio-processed audio content may include at least one of an ambisonics signal, an object signal, or a channel signal. The spatial audio-processed audio content may be a multi-object or a multi-channel signal. In addition, the spatial audio-processed audio may include 2-channel output audio signals respectively corresponding to two ears of a listener. The spatial audio processed-audio content may include a binaural 2-channel output audio signal.

According to an embodiment, the output unit 1300 may include an output part for outputting a spatial audio processed-audio content. For example, the output unit 1300 may include an output terminal for outputting a spatial audio processed-audio content to the outside. In this instance, the spatial audio processing apparatus 1000 may output a spatial audio processed-audio content to an external device connected to the output terminal. The output unit 1300 may include a wireless audio transmission module that outputs a spatial audio processed-audio content to the outside. In this instance, the output unit 1300 may output an output audio signal to an external device using a wireless communication method such as Bluetooth or Wi-Fi.

In addition, the output unit 1300 may include a speaker. In this instance, the spatial audio processing apparatus 1000 may output a spatial audio processed-audio content via a speaker. In addition, the output unit 1300 may additionally include a converter (e.g., a digital-to-analog converter (DAC)) that converts a digital audio signal to an analog audio signal. In addition, the output unit 1300 may be equipped with a display part that outputs a video.

The storage 1400 may store at least one of data or a program used when the processor 1200 performs processing and control. For example, the storage 1400 may store an audio signal on which the processor 1200 is to perform spatial audio processing. In addition, the storage 1400 may store a result obtained by performing an operation in the processor 1200. In addition, the storage 1400 may store data that is input to the spatial audio processing apparatus 1000 or data that is output from the spatial audio processing apparatus 1000.

The storage 1400 may be equipped with at least one memory. In this instance, the memory may include at least one type of storage medium among a flash memory type, a hard disk type, a multimedia card micro type, a card-type memory (e.g., an SD, an XD memory, or the like), random access memory (RAM), static random access memory (SRAM), read-only memory (ROM), electrically erasable programmable read-only memory (EEPROM), programmable read-only memory (PROM), magnetic memory, magnetic disc, and an optical disc.

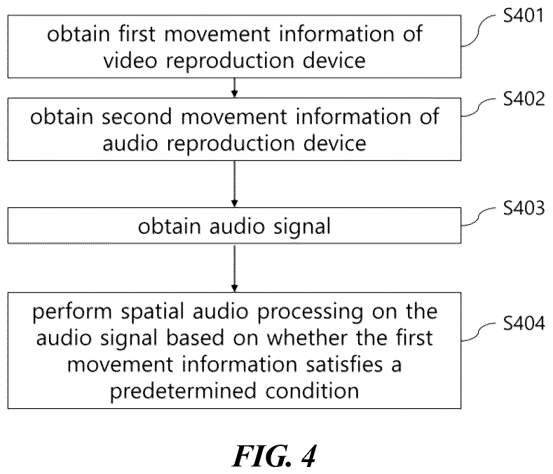

FIG. 4 is a diagram illustrating a spatial audio processing method according to an embodiment of the present disclosure.

FIG. 4 illustrates a spatial audio processing method which has been described with reference to FIGS. 1 to 3. Referring to FIG. 4, a spatial audio processing apparatus may obtain first movement information of a video reproduction device in operation S401. The spatial audio processing apparatus may obtain second movement information of an audio reproduction device in operation 402. The spatial audio processing apparatus may obtain an audio signal in operation S403. Based on whether the first movement information satisfies a predetermined condition, the spatial audio processing apparatus may perform spatial audio processing on the audio signal in operation S404.

In case that the first movement information satisfies the predetermined condition, the spatial audio processing may be performed based on the second movement information. In case that the first movement information does not satisfy the predetermined condition, the spatial audio processing may be performed based on the first movement information and the second movement information.

The first movement information may include at least one of spatial information and direction information of the video reproduction device, and the second movement information may include at least one of spatial information and direction information of the audio reproduction device.

The first movement information may be obtained via an inertial measurement unit (IMU) of the video reproduction device, the second movement information may be obtained via an IMU of the audio reproduction device, and each of the IMU of the video reproduction device and the IMU of the audio reproduction device may include at least one of an acceleration sensor, an angular velocity sensor (gyroscope), and a geomagnetic sensor (magnetometer).

The predetermined condition is the case in which a quaternion value associated with the video reproduction device is greater than a predetermined value, and the quaternion value may be obtained based on a value obtained from at least one of the acceleration sensor, the angular velocity sensor, and the geomagnetic sensor of the video reproduction device.

The predetermined condition satisfies at least one of the case in which an acceleration obtained via the acceleration sensor of the video reproduction device is greater than a first value, the case in which a variation in an angular velocity obtained via the angular velocity sensor of the video reproduction device is greater than a second value, and the case in which a variation in a magnetic field direction obtained via the geomagnetic sensor is greater than a third value. In this instance, the first value, the second value, and the third value may be the same value or may be different values from each other.

The predetermined condition is the case in which the video reproduction device is determined as moving in a predetermined pattern repeatedly based on the first movement information.

The first value, the second value, the third value, and the predetermined value are values configured by learning information associated with a movement of a user of the video reproduction device and the audio reproduction device, and the learning may be performed via machine learning.

The predetermined condition is the case in which the video reproduction device is located beyond a range of an angle of field of the user of the video reproduction device and the audio reproduction device, and the range of the angle of field of the user may be determined based on the audio reproduction device.

The predetermined pattern may correspond to the first movement information repeated during a predetermined period of time.

The video reproduction device may include at least one of a sensor that recognizes a face of a user of the video reproduction device and the audio reproduction device, a sensor that recognizes a direction of a line of sight of the user, and a sensor that recognizes a direction of the face of the user. In this instance, the predetermined condition may satisfy at least one of the case in which the face of the user is recognized, the case in which the direction of the face of the user faces a display of the video reproduction device that displays a video, and the case in which the direction of the line of sight of the user faces the display.

A spatial audio processing method may further include an operation of obtaining information associated with whether the display of the video reproduction device that displays a video is activated. In this instance, the predetermined condition is the case in which the display is deactivated.

The spatial audio processing apparatus described with reference to FIG. 4 may be the spatial audio processing apparatus 1000 described in FIG. 3. Specifically, the spatial audio processing apparatus may include a processor. As described above, the spatial audio processing apparatus may be a video reproduction device 110 or an audio reproduction device 120. In this instance, the processor may perform the spatial audio processing method which has been described with reference to FIG. 4. That is, the processor may be a processor of the video reproduction device 110 or a processor of the audio reproduction device 120.

In some embodiments, it may be embodied in the form of a recording medium including instructions executable by a computer such as a program module implemented by a computer. A computer readable medium may be an available medium accessible by a computer, and may include all of volatile and nonvolatile media, and removeable and unremovable media. In addition, the computer readable medium may include a computer storage medium. The computer storage medium may include all of volatile and non-volatile media, and removeable and unremovable media which, are embodied by a method or technique for storing information such as a computer readable instruction, a data structure, a program module, or other data.

Although the present disclosure has been described with reference to detailed embodiments, those skilled in the art field that the present disclosure belongs to may correct or modify the present disclosure without departing from the subject matter and the scope of the present disclosure. Therefore, it is construed that an idea that those skilled in the art field to which the present disclosure belongs are capable of easily inferring from the detailed descriptions and embodiments of the present disclosure is understood as belonging to the scope of right of the present disclosure.

What is claimed is:

1. A spatial audio processing method, the method comprising:
obtaining first movement information of a video reproduction device;
obtaining second movement information of an audio reproduction device;
obtaining an audio signal; and
performing spatial audio processing on the audio signal based on whether the first movement information satisfies a predetermined condition,
wherein, when the first movement information satisfies the predetermined condition, the spatial audio processing is performed based on the second movement information, and
wherein, when the first movement information does not satisfy the predetermined condition, the spatial audio processing is performed based on the first movement information and the second movement information.

2. The method of claim 1,
wherein the first movement information comprises at least one of spatial information and direction information of the video reproduction device, and
wherein the second movement information comprises at least one of spatial information and direction information of the audio reproduction device.

3. The method of claim 2,
wherein the first movement information is obtained by an inertial measurement unit (IMU) of the video reproduction device,
wherein the second movement information is obtained by an IMU of the audio reproduction device, and
wherein each of the IMU of the video reproduction device and the IMU of the audio reproduction device comprises at least one of an acceleration sensor, an angular velocity sensor (gyroscope), and a geomagnetic sensor (magnetometer).

4. The method of claim 3,
wherein the predetermined condition is a case in which a quaternion value of the video reproduction device is greater than a predetermined value, and
wherein the quaternion value is obtained based on a value obtained from at least one of the acceleration sensor, the angular velocity sensor, and the geomagnetic sensor of the video reproduction device.

5. The method of claim 3,
wherein the predetermined condition satisfies at least one of a case in which an acceleration obtained via the acceleration sensor of the video reproduction device is greater than a first value, a case in which a variation in an angular velocity obtained via the angular velocity sensor of the video reproduction device is greater than a second value, and a case in which a variation in a magnetic field direction obtained via the geomagnetic sensor is greater than a third value.

6. The method of claim 3,
wherein the predetermined condition is a case in which the video reproduction device is determined as moving in a predetermined pattern repeatedly based on the first movement information.

7. The method of claim 5,
wherein the first value, the second value, and the third value are values configured by learning information associated with a movement of a user of the video reproduction device and the audio reproduction device, and
wherein the learning is performed via machine learning.

8. The method of claim 3,
wherein the predetermined condition is a case in which the video reproduction device is located beyond a range of an angle of field of the user of the video reproduction device and the audio reproduction device, and
wherein the range of the angle of field of the user is determined based on the audio reproduction device.

9. The method of claim 6,
wherein the predetermined pattern corresponds to the first movement information repeated during a predetermined period of time.

10. The method of claim 3,
wherein the video reproduction device comprises at least one of a sensor that recognizes a face of a user of the video reproduction device and the audio reproduction device, a sensor that recognizes a direction of a line of sight of the user, and a sensor that recognizes a direction of the face of the user, and
wherein the predetermined condition satisfies at least one of a case in which the face of the user is not recognized, a case in which the direction of the face of the user is not toward a display of the video reproduction device that displays a video, and a case in which the direction of the line of sight of the user is not toward the display.

11. The method of claim 1, further comprising:
obtaining information associated with whether the display of the video reproduction device that displays a video is activated,
in wherein the predetermined condition is a case in which the display is deactivated.

12. A spatial audio processing apparatus for performing spatial audio processing, the apparatus comprising:
a processor,
wherein the processor is configured to:
obtain first movement information of a video reproduction device;
obtain second movement information of an audio reproduction device;
obtain an audio signal; and
perform spatial audio processing on the audio signal based on whether the first movement information satisfies a predetermined condition,
wherein the spatial audio processing is performed based on the second information in case that the first movement information satisfies the predetermined condition,
wherein the spatial audio processing is performed based on the first movement information and the second movement information in case that the first movement information does not satisfy the predetermined condition, and
wherein the spatial audio processing apparatus is the video reproduction device or the audio reproduction device.

13. The apparatus of claim 11,
wherein the first movement information comprises at least one of spatial information and direction information of the video reproduction device, and
wherein the second movement information comprises at least one of spatial information and direction information of the audio reproduction device.

14. The apparatus of claim 13,
wherein the first movement information is obtained via an inertial measurement unit (IMU) of the video reproduction device,
wherein the second movement information is obtained via an IMU of the audio reproduction device, and
wherein each of the IMU of the video reproduction device and the IMU of the audio reproduction device comprises at least one of an acceleration sensor, an angular velocity sensor (gyroscope), and a geomagnetic sensor (magnetometer).

15. The apparatus of claim 14,
wherein the predetermined condition is a case in which a quaternion value associated with the video reproduction device is greater than a predetermined value, and
wherein the quaternion value is obtained based on a value obtained from at least one of the acceleration sensor, the angular velocity sensor, and the geomagnetic sensor of the video reproduction device.

16. The apparatus of claim 14,
wherein the predetermined condition satisfies at least one of a case in which an acceleration obtained via the acceleration sensor of the video reproduction device is greater than a first value, a case in which a variation in an angular velocity obtained via the angular velocity sensor of the video reproduction device is greater than a second value, and a case in which a variation in a magnetic field direction obtained via the geomagnetic sensor is greater than a third value.

17. The apparatus of claim 14,
wherein the predetermined condition is a case in which the video reproduction device is determined as moving in a predetermined pattern repeatedly based on the first movement information.

18. The apparatus of claim 14,
wherein the predetermined condition is a case in which the video reproduction device is located beyond a range of an angle of field of the user of the video reproduction device and the audio reproduction device, and
wherein the range of the angle of field of the user is determined based on the audio reproduction device.

19. The apparatus of claim 14,
wherein the video reproduction device comprises at least one of a sensor that recognizes a face of a user of the video reproduction device and the audio reproduction device, a sensor that recognizes a direction of a line of sight of the user, and a sensor that recognizes a direction of the face of the user, and
wherein the predetermined condition satisfies at least one of a case in which the face of the user is not recognized, a case in which the direction of the face of the user is not toward a display of the video reproduction device that displays a video, and a case in which the direction of the line of sight of the user is not toward the display.

20. The apparatus of claim 11,
wherein the processor is configured to obtain information associated with whether the display of the video reproduction device that displays a video is activated,
wherein the predetermined condition is a case in which the display is deactivated.
